(19) United States
(12) Patent Application Publication
(10) Pub. No.: US 2019/0050868 A1
(43) Pub. Date: Feb. 14, 2019

(54) SYSTEM AND METHOD FOR COMPLAINT AND REPUTATION MANAGEMENT IN A MULTI-PARTY DATA MARKETPLACE

(71) Applicant: Tata Consultancy Services Limited, Mumbai (IN)

(72) Inventors: Manish SHUKLA, Pune (IN); Sachin Premsukh LODHA, Pune (IN); Kishore PADMANABHAN, Chennai (IN)

(73) Assignee: Tata Consultancy Services Limited, Mumbai (IN)

(21) Appl. No.: 16/078,543

(22) PCT Filed: Feb. 22, 2017
(86) PCT No.: PCT/IB2017/051005

§ 371 Date: Aug. 21, 2018

(30) Foreign Application Priority Data
Feb. 22, 2016 (IN) 201621006133

(51) Int. Cl. G06Q 30/00; G06Q 40/04

(52) U.S. Cl. CPC G06Q 30/016; G06Q 30/0185; G06Q 40/04

(57) ABSTRACT

A method and system is provided for managing complaint and reputation in a multi-party data marketplace. The system is managed by an independent external entity to monitor the data transactions in an unbiased manner. The system considers the data as commodity or resource, which is perishable and whose worth might decay with time. The system defines new parameters for reputation and liability calculation (based on complaints), for example, consideration of peer and trust network, history of peering and transaction, automatic decay of reputation and liability in case of inactive participants. According to another embodiment, the disclosure also handles any kind of collusion between external or internal entities/parties/participants. Whereas in another embodiment the disclosure also identifies and restrict influencers in a multi-party data marketplace.

### PRIORITY CLAIM

This application is a U.S. National Stage Filing under 35 U.S.C. § 371 and claims priority from International Application No. PCT/IB2017/051005, filed on Feb. 22, 2017, which application claims priority under 35 U.S.C. § 119 from Indian Application No. 201621006133, filed on Feb. 22, 2016. The entirety of each are incorporated herein by reference.

### TECHNICAL FIELD

The present application generally relates to complaint and reputation management in an online transaction. More particularly, but not specifically, the invention is related to method and system for providing complaint and reputation management in a multi-party data marketplace.

### BACKGROUND

A huge amount of data is available for multiple uses. A lot of business require such data for smooth operation of their business. It is not always feasible to gather or analyze such kind of data. To facilitate this condition, the concept of a data marketplace is getting very popular day by day. A data marketplace is an online platform where users may buy, sell, trade, and/or otherwise transact personal data or any other data captured from other sources with other users for agreed upon compensation and other predefined terms and condition.

In the data marketplace, multiple users are involved simultaneously. The data involved in the transaction in the marketplace could be confidential data. There are a lot of things dependent on the reputation of the users. On the similar lines as of any other online marketplace, the data marketplace has also issues related to the complaint and reputation management. The participants, buyers and sellers, can raise complaint against any of the other participant involves in a transaction. Thus, it is very necessary to have a robust and automated complaint and reputation management system in the data marketplace.

Most of the existing solutions for managing the complaints and reputation are customer centric and cater to multiple small individual buyers and single seller (i.e. B-to-C). Complaint is normally raised for a particular service or product offered by the seller. Data marketplace is normally a B-to-B setup, where large organizations may buy or lease data for analysis and infer business related outcomes.

In addition to that, the scale on which existing systems operate are small and simple. Few proposed solutions which are available for such kind of setup are very rigid as they do not support tunable reputation and liability calculation with respect to complaint. There are few prior art which talk about data as an asset but none of them tackle the issue of aggregation of reputation or liabilities in case of mergers or acquisitions. None of them protects seller's concern in case of an abusive buyer. Most of the existing systems are either customer oriented i.e. they only capture a buyers concern or they don't consider the various stakeholder involved in a single transaction or the distributed nature of the data storage and usage. One other lacking feature is that they don't capture and consider the dynamism of the data and its impact on the complaint management and reputation calculation.

### SUMMARY

Embodiments of the present disclosure present technological improvements as solutions to one or more of the above-mentioned technical problems recognized by the inventors in conventional systems. For example, in one embodiment a system for complaint and reputation management of users in a data marketplace is disclosed. The system comprises a user interface, a memory and a processor in communication with the memory. The user interface for accessing the data marketplace by the users for a data transaction. The processor further configured to perform the steps of: calculating an initial reputation score of each of the users using a reputation calculation module if the user is a new user, else; retrieving and updating the reputation score of the user from a reputation bank; updating the reputation score of the user if there is a complaint against the user, wherein the reputation score is updated after verification as per a first set of predefined conditions; checking if there is an influencer in the data transaction; checking if there is an insider trading in the data transaction, wherein updating the reputation score of each of the users if there is at least one of influencer or insider trading in the data transaction after verification as per a second set of predefined conditions; checking if there is the user inactive in the data marketplace, wherein decaying the reputation score of the user if it is inactive in the data marketplace for more than a specified inactivity time period; gathering a set of insights from the data transaction for future transactions; and updating the final reputation score of each of the users in the reputation bank.

In another embodiment a processor implemented method for complaint and reputation management of users in a data marketplace is disclosed. Initially, the data marketplace is accessed by the users for a data transaction using the user interface. At the next step, an initial reputation score is calculated for each of the users using a reputation calculation module if the user is a new user, else. The reputation score of the user is retrieved and updated from a reputation bank. In the next step the reputation score of the user is updated if there is a complaint against the user, wherein the reputation score is updated after verification as per a first set of predefined conditions. Then it is checked if there is an influencer in the data transaction. It is also checked if there is an insider trading in the data transaction, wherein the reputation score of each of the users is updated if there is at least one of influencer or insider trading in the data transaction after verification as per a second set of predefined conditions. In the next step it is checked if there is the user inactive in the data marketplace, wherein the reputation score of the user is decayed if it is inactive in the data marketplace for more than the specified inactivity time period. A set of insights are then gathered from the data transaction for future transactions. And finally, the final reputation score of each of the users is updated in the reputation bank.

In yet another embodiment, a non-transitory computer-readable medium having embodied thereon a computer program for complaint and reputation management of users in a data marketplace is disclosed. Initially, the data marketplace is accessed by the users for a data transaction using the user interface. At the next step, an initial reputation score is calculated for each of the users using a reputation calculation module if the user is a new user, else. The reputation score of the user is retrieved and updated from a reputation bank. In the next step the reputation score of the user is updated if there is a complaint against the user, wherein the reputation score is updated after verification as per a first set of predefined conditions. Then it is checked if there is an influencer in the data transaction. It is also checked if there is an insider trading in the data transaction, wherein the reputation score of each of the users is updated if there is at least one of influencer or insider trading in the data transaction after verification as per a second set of predefined conditions. In the next step it is checked if there is the user inactive in the data marketplace, wherein the reputation score of the user is decayed if it is inactive in the data marketplace for more than the specified inactivity time period. A set of insights are then gathered from the data transaction for future transactions. And finally, the final reputation score of each of the users is updated in the reputation bank.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 shows a block diagram of a system for providing complaint and reputation management in a multi-party data marketplace in accordance with an embodiment of the disclosure.

FIG. 2 shows a vector representation of reputation of a specific feature in accordance with an embodiment of the disclosure.

FIGS. 3A, 3B, 3C shows a flow chart illustrating the steps involved in managing complaint and reputation of the party in a multi-party data marketplace in accordance with another embodiment of the disclosure.

FIGS. 4A, 4B, 4C shows a flowchart illustrating the steps involved in managing the reputation and complaint filed by the buyer in the data market place in accordance with another embodiment of the disclosure.

FIGS. 5A, 5B, 5C, 5D shows a flowchart illustrating the steps involved in managing the reputation and complaint filed by the seller in the data market place in accordance with another embodiment of the disclosure; and

FIGS. 6A, 6B, 6C, 6D, 6E shows a flowchart illustrating the steps involved in managing the reputation of the seller or the buyer in the data market place in accordance with another embodiment of the disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

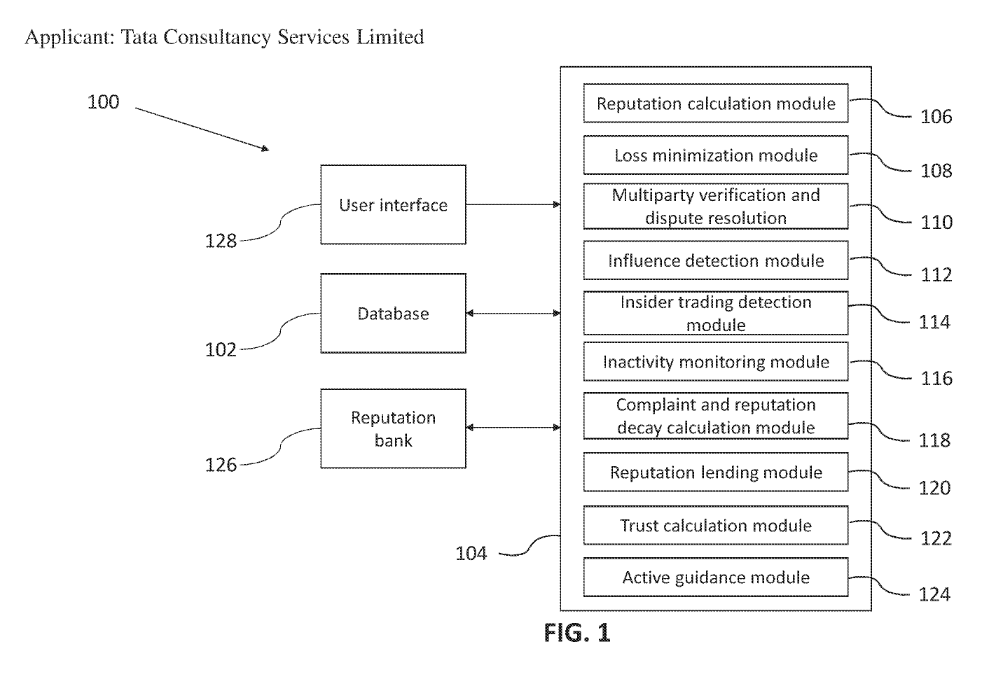

Referring now to the drawings, and more particularly to FIG. 1, where similar reference characters denote corresponding features consistently throughout the figures, there are shown preferred embodiments and these embodiments are described in the context of the following exemplary system and/or method.

FIG. 1 illustrates a schematic block diagram of a system 100 for providing complaint and reputation management in a multi-party data marketplace according to an embodiment of the disclosure. The multi-party data marketplace can involve a plurality of users or a plurality of parties. It should be appreciated that the terms users and parties can be used replaceable in the disclosure. The plurality of parties comprises a plurality of seller parties and a plurality of buyer parties. It should be appreciated that for the sake of convenience, the plurality of buyer parties and the plurality of seller parties herein after will be referred as a set of buyers and a set of sellers respectively. The system 100 keeps track of the concerns of both the buyers and the sellers involved in a data transaction or the distributed nature of the data storage and usage. According to an embodiment of the invention, the system 100 is managed by a central independent entity which keeps track of available data, their characteristics, their quoted worth, their availability, volume, rate of creation and consumption and various other meta-information about it. The central independent entity may also be referred as a platform provider.

According to an embodiment of the disclosure, the system 100 uses data as commodity or resource. It should be appreciated that the data can be static or dynamic. The data is perishable and whose worth might decay or improve with the time. The data can be used as a tradable entity for buying other data points, services, reputation points or resolving any disputes related to an existing complaint. In similar terms as any other commodity, the data can also have a value based on the demand, this can be measured in terms of data credit score. Thus, maintaining high quality data repository means having higher data credit score. The reputation and liability of the parties can be updated based on the complaints involving the parties, for example, consideration of peer and trust network, history of peering and transaction, automatic decay of reputation and liability in case of inactive participants. In an example, the system 100 also handles any kind collusion between external or internal entities/parties/participants.

According to an embodiment of the disclosure, the system 100 includes a database 102, a processor 104. The processor 104 further comprising a reputation calculation module 106, a loss minimization module 108, a multiparty verification and dispute resolution module 110, an influencer detection module 112, an insider trading detection module 114, an inactivity monitoring module 116, a complaint and reputation decay calculation module 118, a reputation lending module 120, a trust calculation module 122 and an active guidance module 124. It should be appreciated that the processor 104 may also include other modules for performing various functions of the data marketplace. The database 102 is configured to store all the information involved during the data transaction. The database 102 may also include a reputation bank 126 for storing reputation scores of the parties. The system 100 classify the users using the data marketplace based on various criteria.

The system 100 also includes a user interface 128 for accessing the data marketplace by the users. The user interface 128 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the user interface device(s) can include one or more ports for connecting a number of devices to one another or to another server.

According to an embodiment of the disclosure, the reputation of the user is used as an asset to the person, while the complaints against the buyers or sellers is referred as the liability. In another example, the reputation can also be used as the asset to the organization in B-B setup. The reputation is calculated by the reputation calculation module 106. The reputation calculation module 106 calculates a reputation score of the parties. The reputation calculation module 106 calculates party's reputation score as a function of various parameters such as history, affiliation, quality, corpus size, trust, delivery time, market reach, payment time, request frequency, complaints and peer network. These parameters are constantly changing based on newly identified patterns in the market. Depending upon the party's role i.e. buyer or seller, a set of parameters can be picked from the above mentioned various parameters. This will help in incorporating meta-information about the party while calculating its reputation score. For example, for a seller, history and peer information can be used for figuring any collaboration with malicious party and hence lower reputation score. Although a higher existing reputation, and collaboration with malicious/new party may depict/convey a risk taking aggressive party in the data marketplace.

In an example, the reputation score of the parties can be calculated as follows. The combined reputation formula is provided as shown below:

Feature Set for a Buyer and a Seller:

A={α₁, α₂, . . . , αₙ} and B={β₁, β₂, . . . , βₘ}
Where, A is feature set for a seller and B is feature set for buyer
Also, ζ_{A} & ζ_{B} is the karma point earned by an entity between time (τ−1, τ)

Damping Constant (λ)

λ_{α}_{ₖ}=f(αₖ), Where, αₖ ∈ A

λ_{β}_{ⱼ}=f(βⱼ), Where, βⱼ ∈ B
Also, 0<λ≤1

Change Constant (δ)

δ_{A}=λ_{A}*size(data)/max(data)

δ_{B}=λ_{B}*size(data)/max(data)

### Reputation at Time τ for a Seller:

R_{A}_{_{τ}}=(1−λ_{A})*F_{A}_{_{τ−1}}+δ_{A}

Penalty at Time τ for a Seller:

R_{A}_{_{τ}}=(1−δ_{A})*F_{A}_{_{τ−1}}

Where, F_{A}_{_{τ−1}}=f(A, τ−1)+ζ_{A}

Reputation at Time τ for a Buyer:

R_{B}_{_{τ}}=(1−δ_{B})*F_{B}_{_{τ−1}}δ_{B}

Penalty at Time τ for a Buyer:

R_{B}_{_{τ}}=(1−δ_{B})*F_{B}_{_{τ−1}}

Where, F_{B}_{_{τ−1}}=f(B, τ−1)+ζ_{B}

Total Reputation of an Entity at Time τ:

R_{τ}=R_{τ}_{_{S}}+R_{τ}_{_{B}}

The reputation can also be represented as an N dimensional Vector as shown below

Feature Set for a Buyer and a Seller:

A={\vec{α₁}, \vec{α₂}, . . . , \vec{αₙ}} and B={\vec{β₁}, \vec{β₂}, . . . , \vec{βₘ}}
Where, A is feature set for a seller and B is feature set for buyer
Also, ζ_{A} & ζ_{B} is the karma point earned by an entity between time (τ−1, τ)

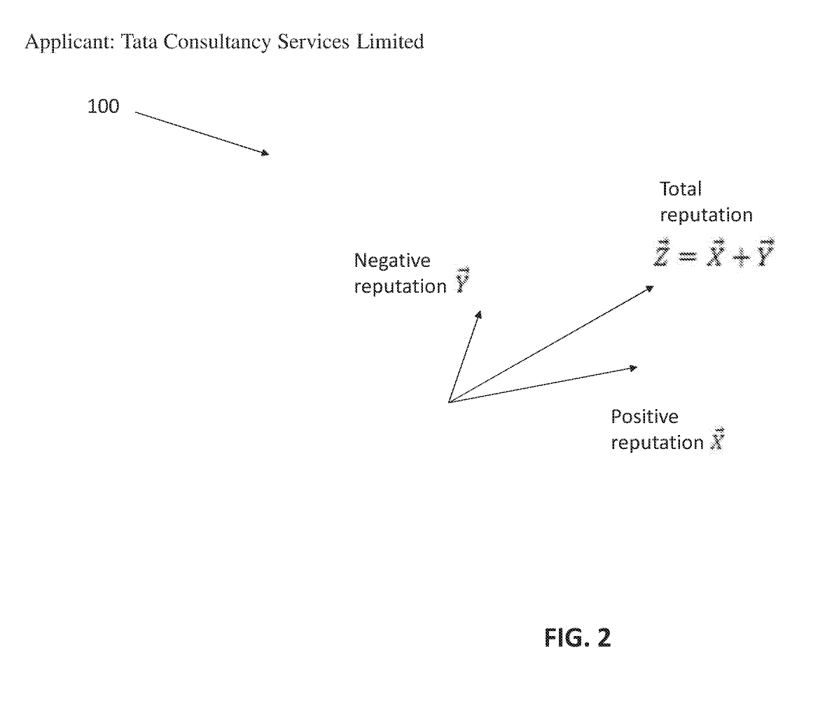

Now consider that a reputation for a specific feature can be represented as a vector itself as shown in FIG. 2,

So, this implies that

αₖ=αₖ_{ₓ}+αₖ_{_{y}}, and

βₖ=βₖ_{ₓ}+βₖ_{_{y}}

Damping Constant (λ)

λ_{α}_{ₖ}=f(αₖ), Where, αₖ∈A

λ_{β}_{ⱼ}=f(βⱼ), Where, βⱼ∈B
Also, 0<λ≤1

Change Constant (δ)

δ_{α}_{ₖ}=λ_{α}_{ₖ}*size(data)/max(data)

δ_{β}_{ₖ}=λ_{β}_{ₖ}*size(data)/max(data)

Reputation at Time τ for Feature αₖ of Seller:

$${R}_{{α}_{{k}_{x}}} ( τ ) = ( 1 - {δ}_{{α}_{k}} ) * {F}_{{α}_{{k}_{x}}} ( τ ) + {δ}_{{α}_{k}}$$

$$Where , {F}_{{α}_{{k}_{x}}} ( τ ) = f ( {α}_{{k}_{x}} , τ - 1 ) + {ζ}_{A}$$

Penalty at Time τ for Feature αₖ of Seller:

$${R}_{{α}_{{k}_{y}}} ( τ ) = ( 1 - {δ}_{{α}_{k}} ) * {F}_{{α}_{{k}_{y}}} ( τ )$$

$$Where , {F}_{{α}_{{k}_{y}}} ( τ ) = f ( {α}_{{k}_{y}} , τ - 1 ) + {ζ}_{A}$$

Total Reputation for Feature αₖ at Time τ

$$\vec{{R}_{{α}_{k}}} ( τ ) = \vec{{R}_{{α}_{{k}_{x}}}} ( τ ) + \vec{{R}_{{α}_{{k}_{y}}}} ( τ )$$

Total Reputation of Seller at Time τ

$$\vec{{R}_{A}} = \vec{{R}_{{α}_{1}}} + \vec{{R}_{{α}_{2}}} + … + \vec{{R}_{{α}_{n}}} = {\sum }_{i = 1}^{n} \vec{{R}_{{α}_{l}}}$$

$$Or , ‖ {R}_{A} ‖ = ‖ {R}_{{α}_{1}} ‖ + ‖ {R}_{{α}_{2}} ‖ + … + ‖ {R}_{{α}_{n}} ‖$$

Similarly, Total Reputation of Buyer at Time τ

$$\vec{{R}_{B}} = \vec{{R}_{{β}_{1}}} + \vec{{R}_{{β}_{2}}} + … + \vec{{R}_{{β}_{m}}} = {\sum }_{j = 1}^{m} \vec{{R}_{{β}_{j}}}$$

$$Or , ‖ {R}_{B} ‖ = ‖ {R}_{{β}_{1}} ‖ + ‖ {R}_{{β}_{2}} ‖ + … + ‖ {R}_{{β}_{m}} ‖$$

Total Reputation of an Entity at Time τ

\vec{R}=\vec{R_{A}}+\vec{R_{B}}

Or, ∥R∥=∥R_{A}∥+∥R_{B}∥

According to an embodiment of the disclosure, the system 100 also takes care of the scenario where the buyer is malicious/mischievous and does not use the provided content as per the signed SLA. Depending on the impacted/misused data points the buyer's reputation score will be recalculated on predetermined intervals or relief given to the seller in case of a complaint submitted by the malicious/mischievous party.

According to an embodiment of the disclosure, the system 100 also maintains the historical records of complaints, their symptoms and their remediation. All this will be classified as per certain topic modelling technique like Latent Dirichlet Allocation (LDA) or information retrieval technique like tf-idf frequency for easy searching and querying. In case of a new complaint the system 100 will provide or suggest possible remediation techniques from its past experience. This will help in reducing false positives and fix turnaround time.

The system 100 also provides distributed complaint management and reporting. In the data marketplace, the buyer and the seller might have data repositories on virtually, logically or physically distributed nodes. In such a scenario there will be cases of single/multiple node failure while sending (for seller) or processing (for buyer). The present disclosure provides a technique for complaint resolution by capturing the information about the replica nodes in service level agreement (SLA) and associated cost/incentive models for doing that. This will help in continuous data flow to buyer and an incentive model for seller to maintain its reputation and occasional extra revenue. Apart from this the technique will only calculate the differential impact on reputation as per the number of dysfunctional nodes. For instance, a seller will have higher reputation for maintaining redundancy as buyers will have unrestricted flow of data. Again they may be penalized for any delay in delivery of the data points.

According to an embodiment of the disclosure, the system 100 also includes the loss minimization module 108 to minimize the loss or exposure of the confidential data by capturing the security and privacy controls provided by the buyer. Implementation of which could be active if it provides active monitoring or passive if captures the information in document or any other static service level agreement. The loss minimization module 108 evaluates the buyer's capability for providing a secure environment for data usage, it is particularly important if the data consists of PII (Personally Identifiable Information), PHI (Protected Health Information) or any other sensitive information. In case of a threat, whether inside or outside, the buyer should minimize the impact on the seller. A buyer should maintain this capability as high as they can because this will establish their readiness for any contingency and as well as capability for handling volatile and toxic data. The loss minimization module 108 evaluates the buyer's capability for providing a secure environment for data usage. The loss minimization module 108 is used to assess the disclosed measures and controls deployed by the buyer.

According to an embodiment of the disclosure, the system 100 includes the multiparty verification and dispute resolution module 110. The multiparty verification and dispute resolution module 110 provides secure multi-party verification of disputed data by exposing the data to the larger data marketplace community, wherein independent parties may assess its quality and notify the platform provider about the result and completes the secure multi-party verification process. The independent and anonymous evaluators will get karma points for their help. The karma points could be in the form of some virtual or actual currency or data exchange or compute cycles or other fungible good or commodity. In the case of multi-party computation which is a subfield of cryptography, the plurality of parties jointly compute a function over their inputs while keeping those inputs private. Whereas in multi-party verification the plurality of parties apply their proprietary algorithm/solution/tool on a common data while keeping the algorithm/solution/tool private. This feature helps in two scenarios. 1) Dispute resolution—In case a dispute between the seller and the buyer, this allows independent parties to evaluate the quality of the data sold by the seller to the complainer and share their result with the platform provider. 2) Sandbox environment—Could be used by the prospective buyers to sample some representative data before buying it from the seller. This feature will ensure higher reputation for the seller.

In the secure multiparty verification process the disputing parties go to the platform provider with their concern/issue which then may decide to involve other parties to verify the sanity, quality, quantity and other features of the disputed dataset. In one of the instance, the platform may disclose a part or complete dataset in a time bound arena without disclosing the identity of the disputing parties. Other independent and unrelated participants may choose to assess the disputed points and may run their proprietary algorithms on the sample dataset and provide their feedback to the platform. This feedback can then be used for resolving the dispute between the parties. The participating parties here doesn't know anything about the disputing parties or other participating verifiers and also they don't have to disclose their verification algorithm. On settlement of the dispute some karma points will be distributed to the participating parties based on the quality of the feedback. The quality will be assessed on the basis of quality matrices defined by the platform or mutually agreed upon by the disputing parties.

According to an embodiment of the disclosure, the system 100 also takes care of the impact of dynamic data on complaint filing. The system 100 also helps in reducing the number of false complaints due to the buyer's own faulty logic/algorithm/processing. When working with static data the buyer may need to do multiple iterations to ensure whether the problem is with the shared content. In a given setup where data is streamed to the buyer there might be a scenario where the buyer may face an issue with the data. Now, the buyer has to decide between report fast vs report safe i.e. report as soon as the problem is faced or do some kind of exception handling and process more data and if the problem persists then report. This is particularly useful in streaming data delivery as it might result in false complaint filing and disrupting processing of real-time/streaming content. If the problem is on the buyer's side then it will impact their reputation score. Whereas if they play safe and try to provide a cushion for exceptional scenarios then they might risk on loosing critical data points and also have to provide additional infrastructure or code or logic to handle exceptional scenarios. The buyer maintaining this kind resilience in their infrastructure will have higher reputation point. In addition to that, the data processing window is short and their might not be persisted. Therefore, if a buyer includes extra code or deploy additional storage pool to accommodate and reanalyze any issue then they should be given additional reputation as they don't put additional load on the system and over populate a platform's complaint queue.

According to an embodiment of the disclosure, the system 100 is configured to be used when there are more than two parties are involved in the single transaction and one of the party is malicious party. In this case, the system 100 assigns a group reputation score in addition to the individual reputation scores of the parties. In case of the malicious party, then the group's reputation score will go down. Apart from this, other participants will also see some reduction in their scores based on history of previous cooperation with the malicious parties, their current peer network and their own standing in the market. This will ensure that slowly but steadily all malicious parties will be signaled and sidelined.

According to an embodiment of the disclosure the system 100 further includes an influencer detection module 112 in a multi-party transaction. The influencer detection module 112 is configured to be used when one of the party is trying to influence the data transaction. In addition to that, the influencer detection module 112 also configured to detect if one of the party is trying to ruin the reputation of the other parties or their own collaborators. To avoid such allegation and scenarios, the influencer detection module 112 uses the previous history and rating trends of entities and their nearest neighbors in the peer network. If an influencing party is found then appropriate actions are taken, for example, applying penalties on influencers or damping their given rating. The influencer detection module 112 breaks such networks so that overall neutrality of the system remains unquestionable. The system 100 also configured to detect the fake data transactions.

According to an embodiment of the disclosure, the insider trading detection module 114 is configured to detect any kind of collusion between related parties, wherein they are related and buy from and sell data to each other. This way they will keep boasting each other's reputation and other vital statistics. According to another embodiment of the disclosure, the complaint and reputation decay calculation module 118 will remove any inactive complaint from the queue. This is important because it removes dead complaints from the queue and also helps in maintaining healthy reputation management.

According to another embodiment of the disclosure, the reputation lending module 120 acts like a virtual bank for reputation wherein a participant with higher or sufficient reputation point might want to help a new entrant in exchange of some prescribed benefits. According to another embodiment of the disclosure, the active guidance module 124 keeps track of old issues and their remediation. It tags and index all historical items and may suggest as a solution to a complainer in case of similar or near matching tags or queries or keywords.

The system 100 also configured to check the activeness of the parties. According to an embodiment of the disclosure, the inactivity monitoring module 116 is configured to identify and remove inactive participants from the marketplace if any participant or user is inactive for more than a specified inactivity time period. In a multiparty data marketplace there could be two scenarios. In the first scenario, the seller becomes inactive—In such case her reputation decays with time. This is done as the seller might not have the latest trends and data points. Although, in some exceptional cases the worth of historical data might increase. In the second scenario, the buyer becomes inactive—In such case any complaints which are pending and needs buyer's attention will decay with time. This is done to avoid any unjustified penalizing of the seller or vice versa. This feature helps in keeping inactive entities/parties outside the mainstream, and hence, crowding of the data marketplace.

According to another embodiment of the disclosure, the system 100 includes the reputation bank 126. Whenever a new party joins the marketplace, it start with a default reputation score, though, every so often, to sell a particular item the new party may require higher reputation score. Earning the minimal required amount of reputation will require some time, and hence may result in loss due to competition. The reputation bank basically operates like a normal bank but deals in reputation points. The operation of the reputation bank can be explained with the following example. The reputation bank participant with higher reputation and trust score depositing a part of their scores in the bank, provided and managed by the platform provider. The reputation bank will lend the required/requested reputation to the new entrant, though the reputation bank will require some kind of collateral. In case of successful sale the reputation bank will charge some percent of the profit and release the collateral. In addition to that, the reputation bank will keep a part of the earning and shares the remaining amount with the depositors in accordance with their % deposit. It should be appreciated that the reputation bank may also provide various other technique.

According to another embodiment of the disclosure, the system 100 also employs a trust ranking algorithm for updating of the reputation score. Reputation is not prediction of the future, but knowledge of the past. Whereas, trust is a measure of something which is associated with future. Through the present complaint and reputation management system it is possible to get trustworthiness score of a participant party. In similar lines the trust calculation module 122 calculates the trustworthiness of a participant by considering the factors, though not limited to these, time of delivery, quality, duration, corpus, reputation, data return filing, affiliation, collaboration network etc. To accomplish this the system 100 employs multiple algorithms, for example, a simple algorithm may use history, order frequency, delivery and payment time, reputation and trust score of the nearest neighbors in the peer network. The party connected with higher ranking peer will have higher score as compared to the party which is connected with a low ranking party. In other words, the system promotes good behavior, better data quality and value added services because only then higher ranking party's entities will connect with a lower ranking party.

According to an embodiment of the disclosure, the system 100 also provides a feature of data returns. The purpose of filing of data returns is to create or update transactional records with the data marketplace platform. This record is favorably looked upon or used by the other participating entities like reputation bank, buyers or sellers, platform etc. It also suggest that the filer is a law abiding party and is active/alive in that fiscal quarter/year. In an example, the system and method we use it as one of the feature to calculate reputation of an entity. A party with good data return history might get certain privileges like higher threshold or cushioning from self-reputation deduction by filing false complaint or might get a first predetermined karma points than normal party (relatively new entrants or misbehaved parties) by participating in multi-party secure verification. To other parties it is also an indicator of one's market reach, change in corpus size, number of transaction happened (we don't disclose with whom these transaction happened), kind and number of complaints filed by/against the party and their current status/resolution. Above use cases are for just for illustrative purposes and may include many other such use-cases.

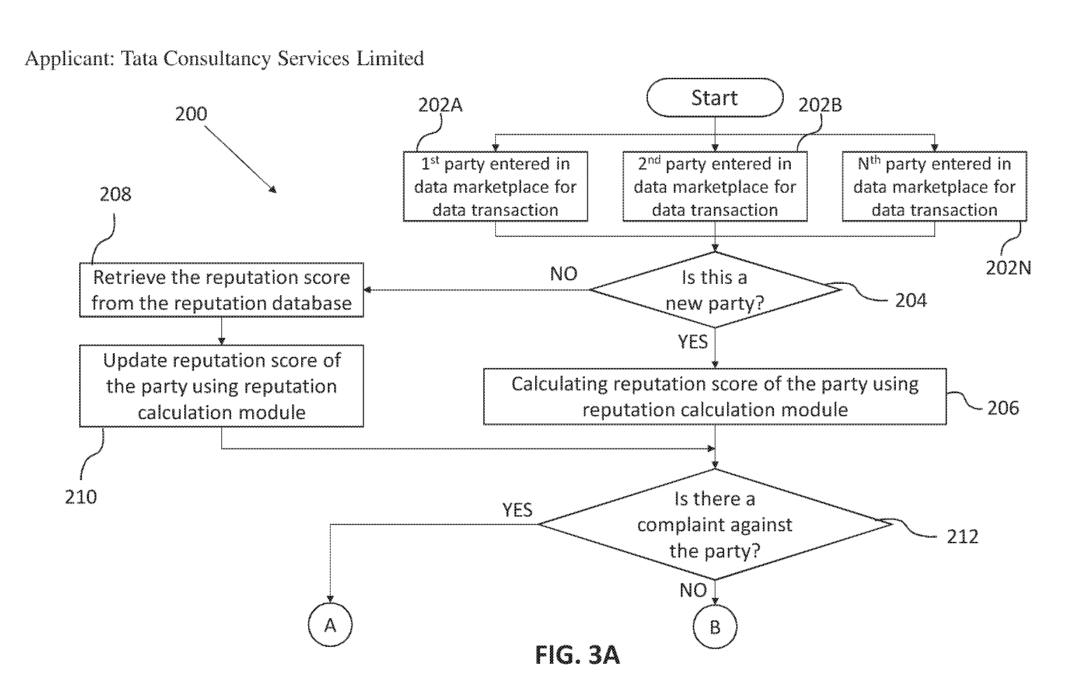

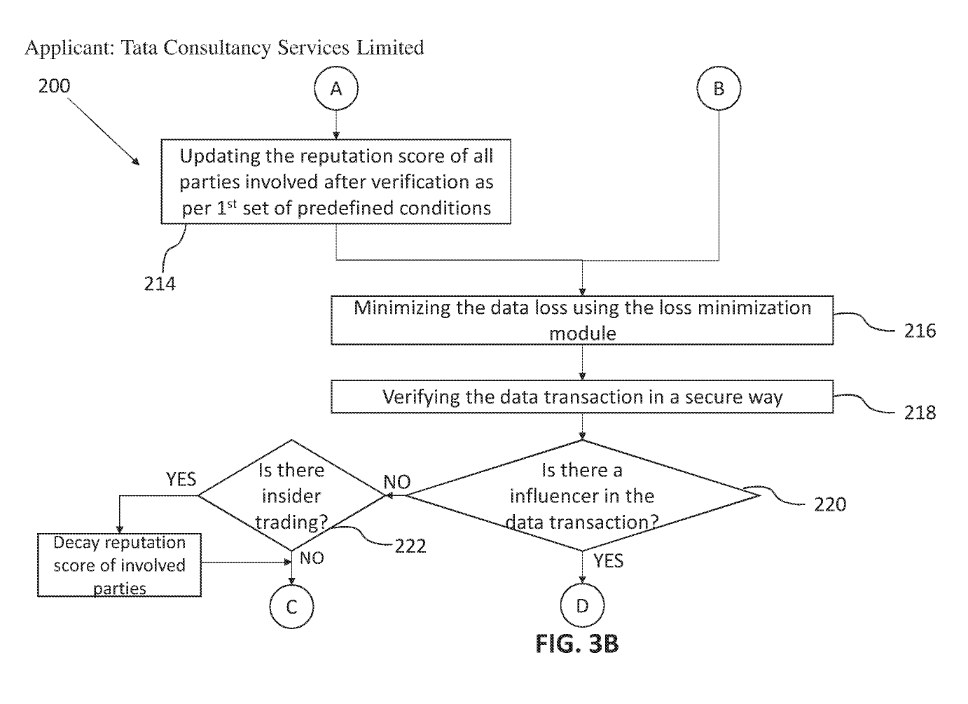

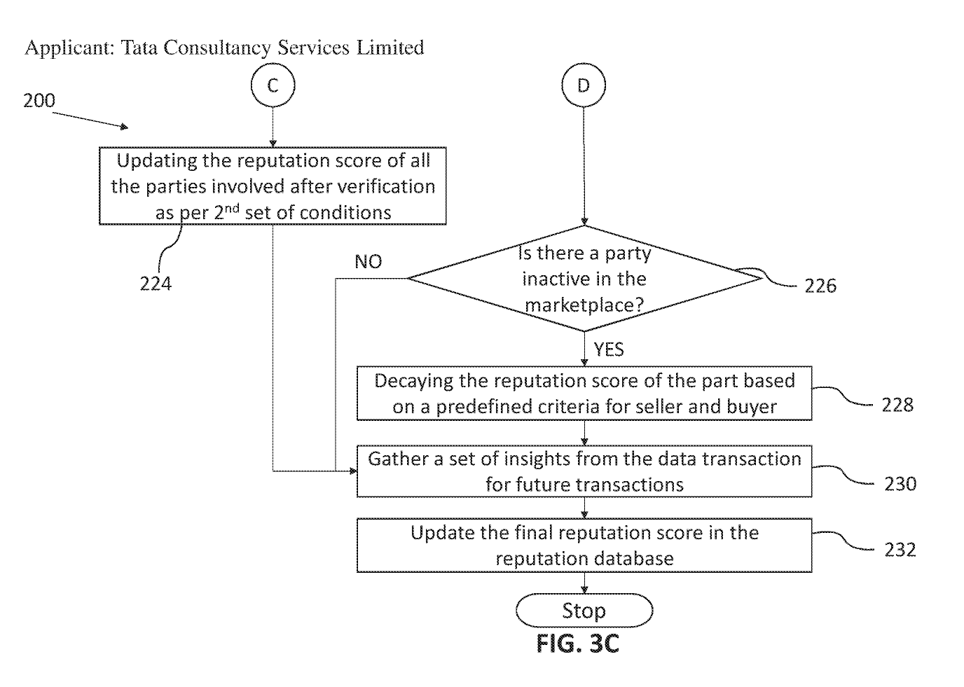

In operation, a flowchart 200 illustrating the steps involved in managing complaint and reputation of the party in a multi-party data marketplace is shown in FIGS. 3A, 3B, 3C according to an embodiment of the disclosure. Initially at step 202, the data market place is accessed by the users using the user interface 128. In other words, at least one party is entered in the data market place. In an example the entering the first party is shown at step 202A, entering the second party is shown at step 202B, and entering the N^{th} party is shown at step 202N. At step 204, it is checked by the processor 104 for each of the party that whether the party is new or not. If party is new, then at step 206, the initial reputation score of the party is calculated using the reputation calculation module 106. The reputation score can be calculated the formula mentioned above. If the party is not new, then at step 208, the old reputation score of the party is retrieved from the reputation bank 126. In the next step at 210, the reputation score of the party is updated based on the old reputation score retrieved from the reputation bank 126.

In the next step 212, it is checked that, is there any complaint filed by the party or filed against the party. If the party is involved in any complaint, then at step 214, reputation score of the party is recalculated and updated after verification as per first set of predefined conditions. The first set of predefined conditions takes care of various criteria for verifying the validity of the complaint. It should be appreciated that after the verification, the reputation score of the party my get increased or decreased. If the party is not involved in any complaint, then at step 216, data loss is minimized in the data transaction using the loss minimization module 108. In the next step 218, if there is a dispute related to quality or usability of the data then the data set in question is verified by the multiparty secure verification and dispute resolution module 110. The multiparty secure verification allows the third party verifiers to hide their intellectual property in the form code, algorithm or similar instrument. Also, the module facilitates blind verification which stops any kind of bias for or against the disputing parties.

In the next step 220, it is checked that is there any party who is influencing the data transactions for their personal benefits. If yes, then at step 222, the reputation score of all the involved parties are updated after the verification as per a second set of predefined conditions. The second set of predefined conditions includes criteria for verifying the validity of influencer and the insider trader. It is verified that whether actually a buyer or the seller is trying the influence the data transaction. If there is no influencing then, at step 222, it is checked whether there is an insider trading the data transaction. If yes then at step 224, the reputation score of all the parties are further updated, else at step 226, it is checked that whether there is any inactive party in the data marketplace. If there is any inactive party for more than the specified inactivity time period then at step 228, the reputation score is updated once again based on a third set of predefined conditions. It should be appreciated that the predefined set of conditions are different for the seller and are different for the buyer. In the next step 230, a set of insights are gathered from the data transaction for future transactions. And finally at step 232, the reputation score of each of the involved parties is updated with the final reputation score in the reputation bank 126.

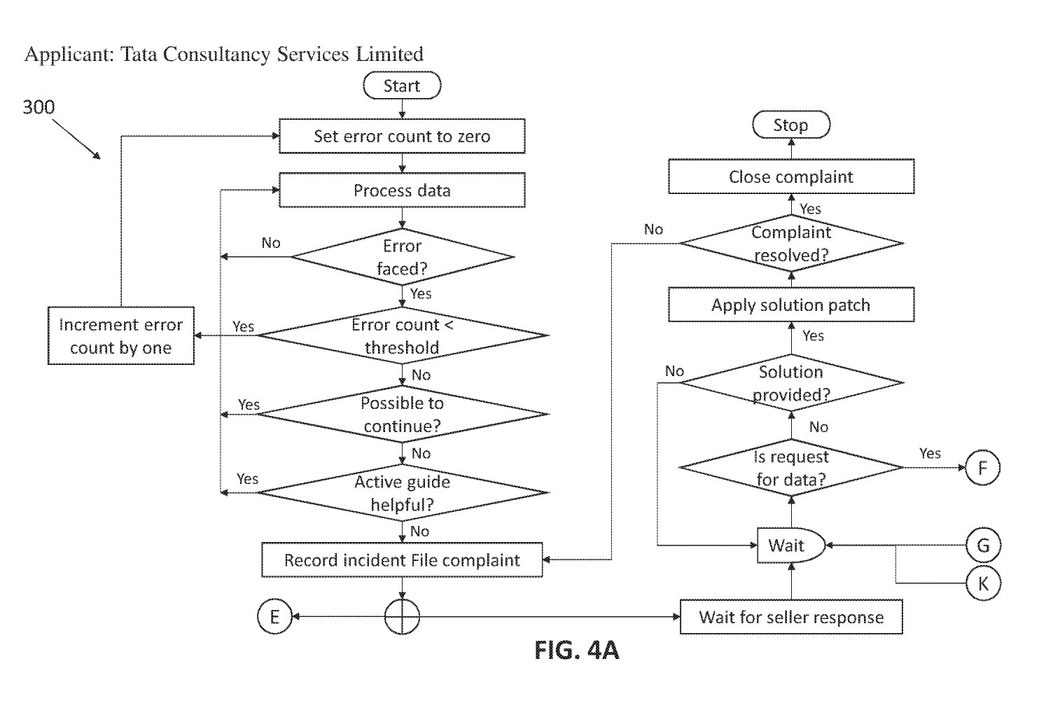

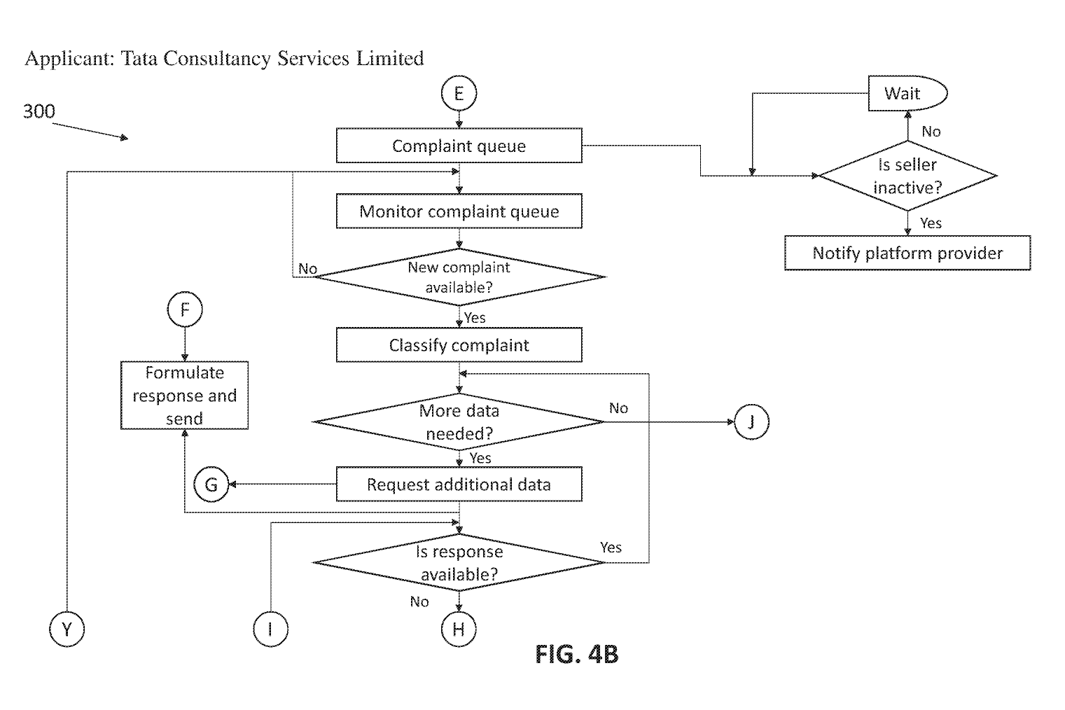

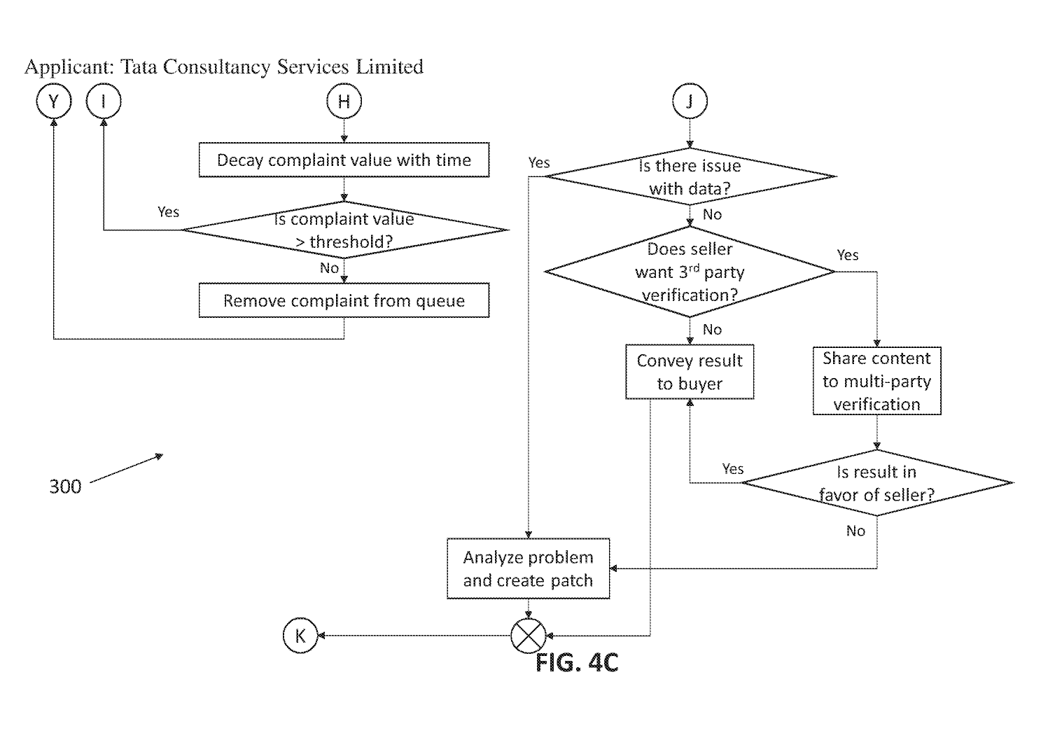

FIGS. 4A, 4B, 4C shows a flowchart 300 illustrating the steps involved in managing the reputation and complaint filed by the buyer in the data market place. It should be appreciated that the flowchart 300 should be read in conjunction with explanation of various modules and steps as explained in FIG. 1 and FIGS. 3A, 3B, 3C. Initially, three aspects are checked by the processor. First, whether the number of errors has crossed a predefined threshold, second these errors are not handled by the buyer and third, active guidance is helpful or not. After that the complaint is filed by the buyer, the buyer can either wait for the seller's response or the complaint goes to the seller's queue. Once the complaint is in the seller's queue, then the seller can classify the complaint. After that, three aspects are checked by the seller, first whether more data needed, second is there any issue with product or data and third, does the seller want the third party verification. If issue is with the data, then the problem is analysed and a patch is created. If 3^{rd} party verification is required then the content is shared for verification. If there is more data needed, then additional data is requested by the seller. If additional data is not provided by the buyer in stipulated time then complaint value is decayed over the time. If complaint value is less than a threshold then the complaint is removed from the queue and the process is stopped. At the same time, as mentioned earlier, when the buyer is waiting for the response he checks whether data is requested by the seller, if yes then the seller formulate the response and send it back to the buyer. Finally the seller checks if a satisfactory solution is provided by the buyer for his complaint. If yes, then the solution is applied and the complaint is closed by the buyer.

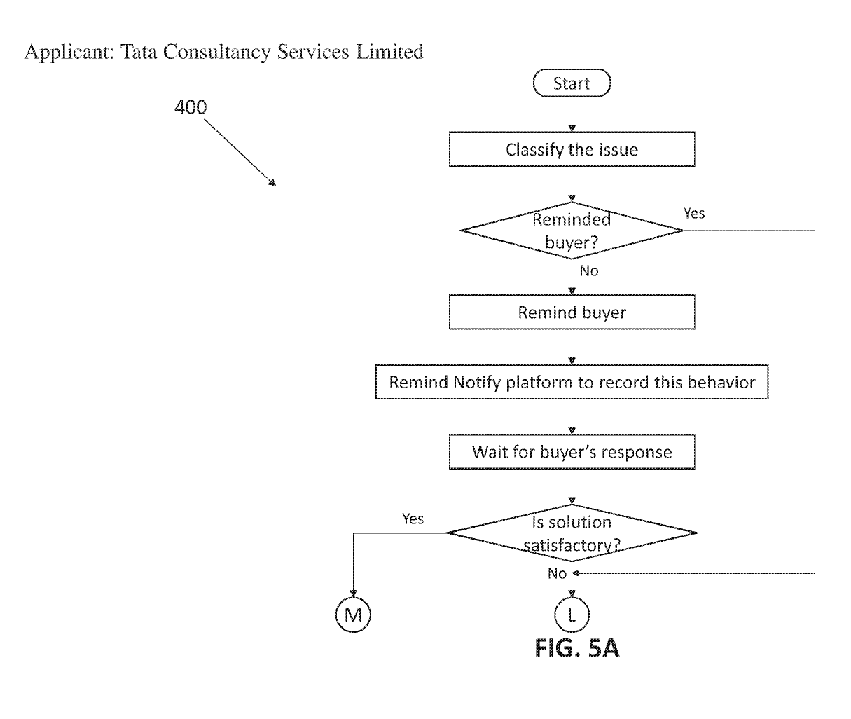

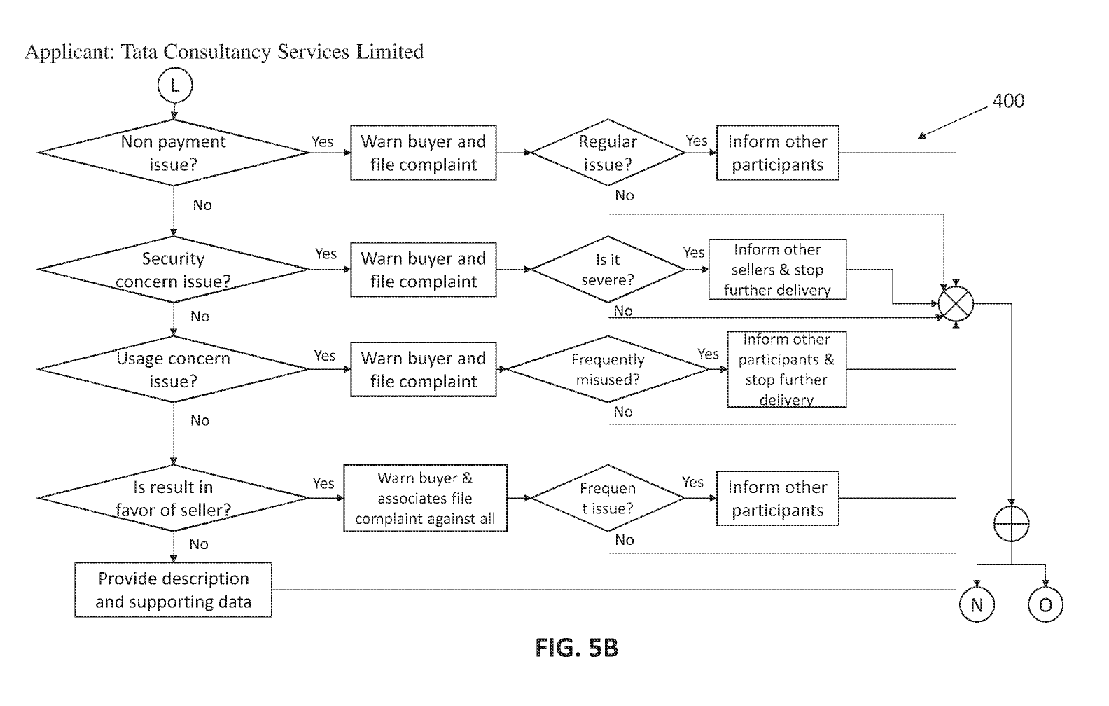

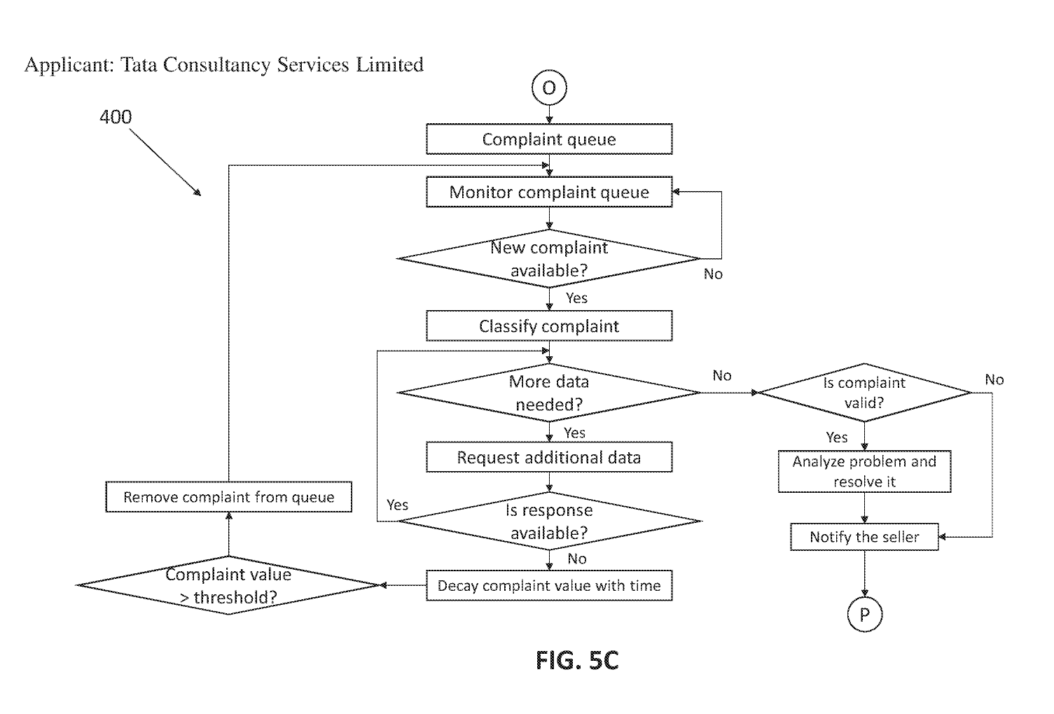

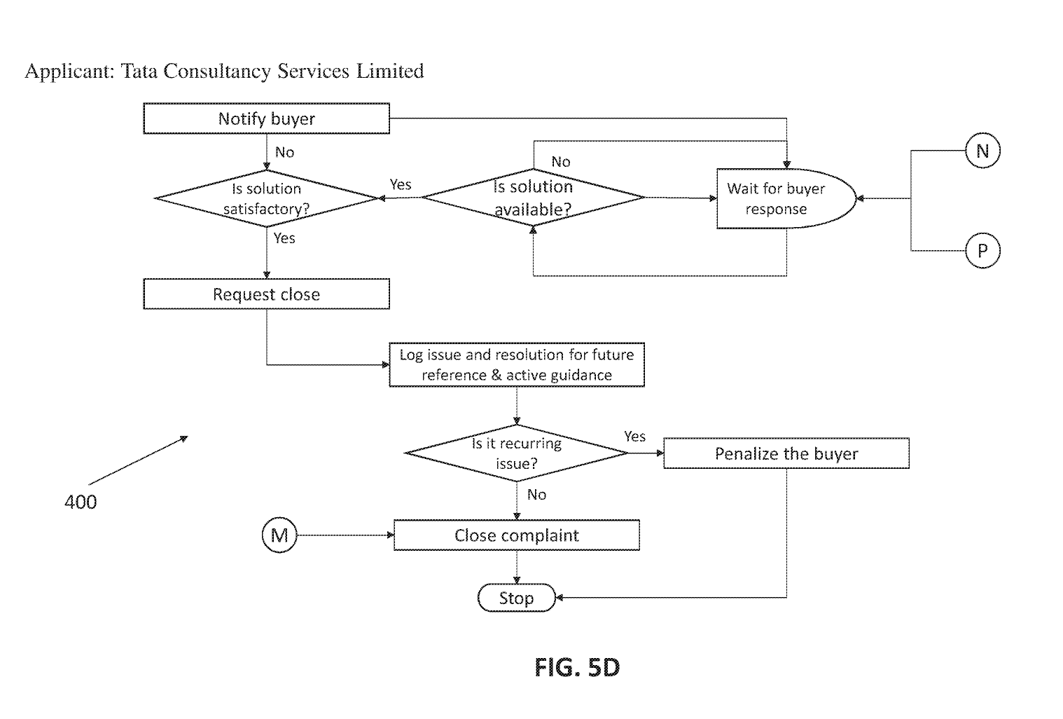

FIGS. 5A, 5B, 5C, 5D shows a flowchart 400 illustrating the steps involved in managing the reputation and complaint filed by the seller in the data market place. It should be appreciated that the flowchart 400 should be read in conjunction with explanation of various modules and steps as explained in FIG. 1 and FIGS. 3A, 3B, 3C. Initially, the issue is classified by the seller. In the next step the seller reminds the buyer. Based on the complaint the buyer provides the solution. If solution is not satisfactory, then the seller checks four aspects. First, if there is a non-payment related issue then the seller files the complaint and inform the participating parties. Second, if there is a security then the seller files the complaint and inform the participating parties. Third, if there is a usage concern issue the seller files the complaint and inform the participating parties. Fourth, is there an insider sharing or external influencer, then warn the buyer and files complaint against all the related participating parties.

Once the complaint is filed then either the seller can wait or it goes in the buyer's queue. Once the complaint is in the buyer's queue, the buyer classifies the complaint. In the next step, the buyer requests for additional data if needed. If additional data is not provided in stipulated time then complaint value is decayed over the time. If complaint value is less than a threshold then the complaint is removed from the queue. At the same time, as mentioned earlier, when the seller is waiting for the response finally the seller checks if a satisfactory solution is provided by the buyer for his complaint. If yes, then the solution is applied and the complaint is closed by the seller.

In the next step when the request is closed, the issue and resolution is logged at the platform provider's end for future reference and active guidance. The platform provider checks if this is a recurring issue, then the buyer/seller is penalized for repeating their misconduct.

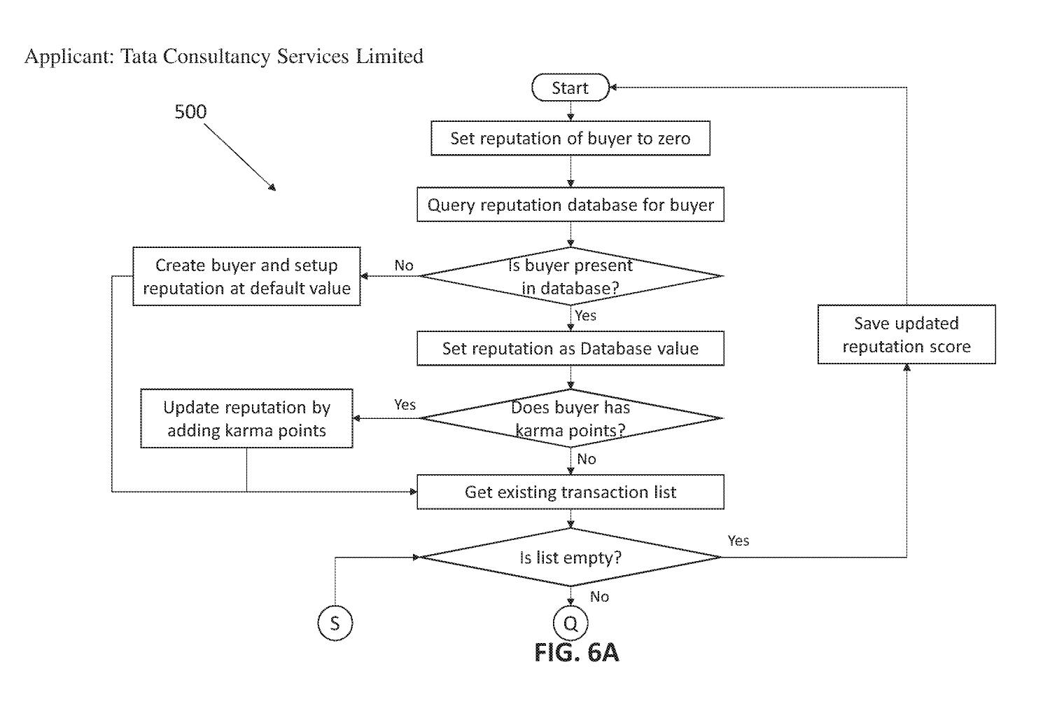

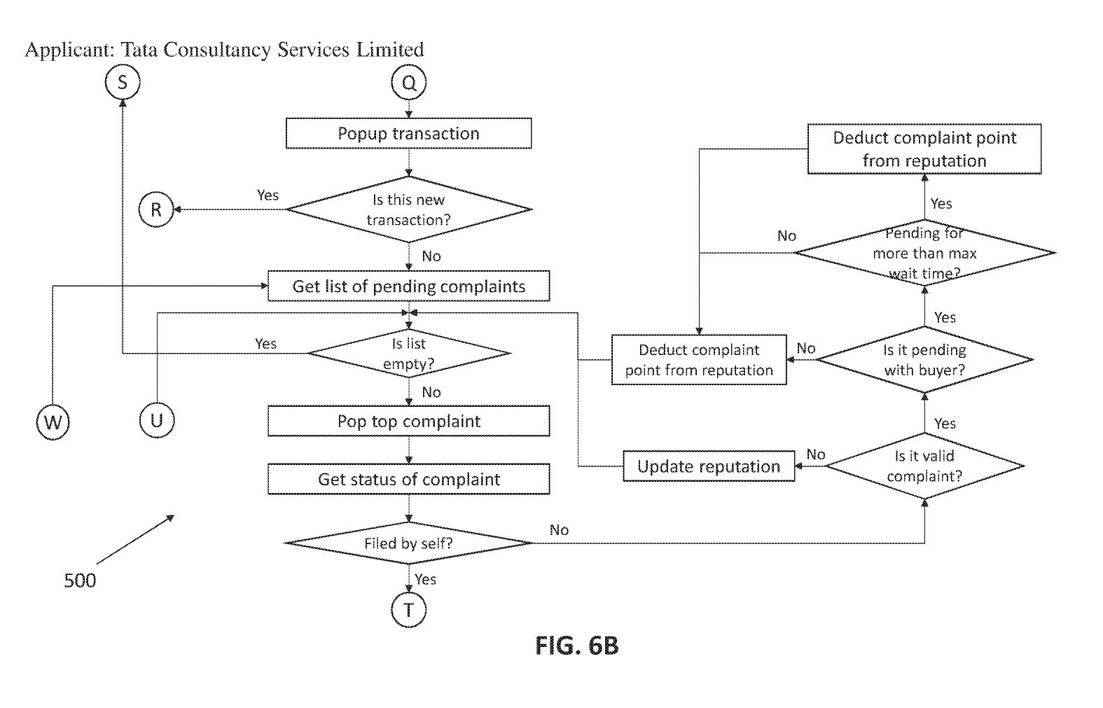

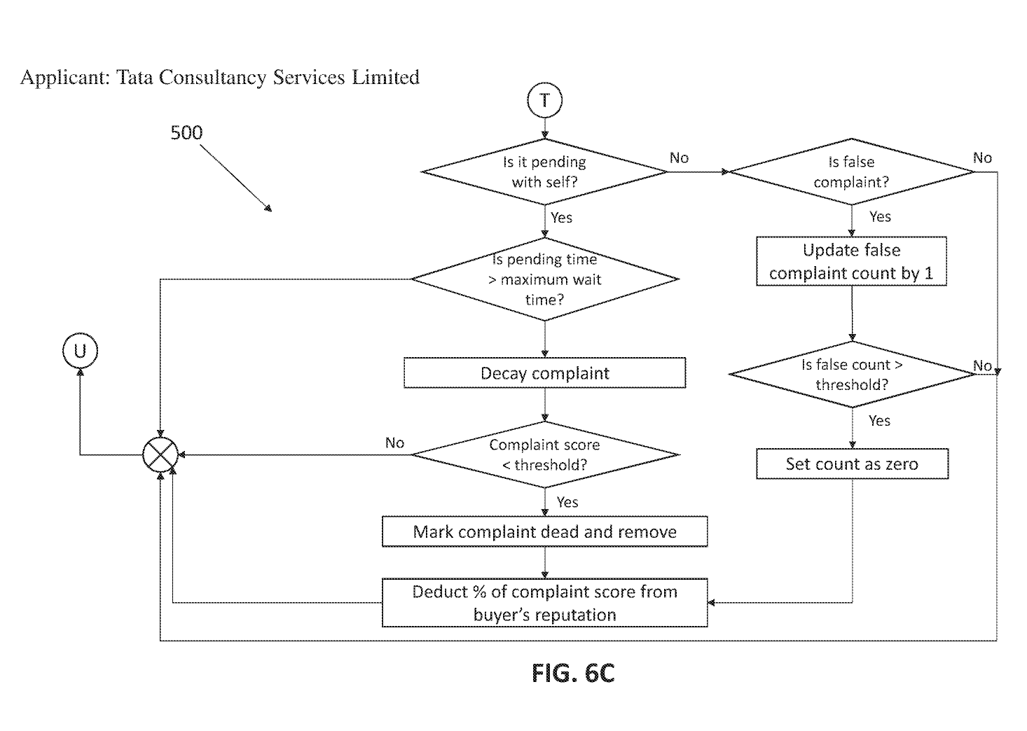

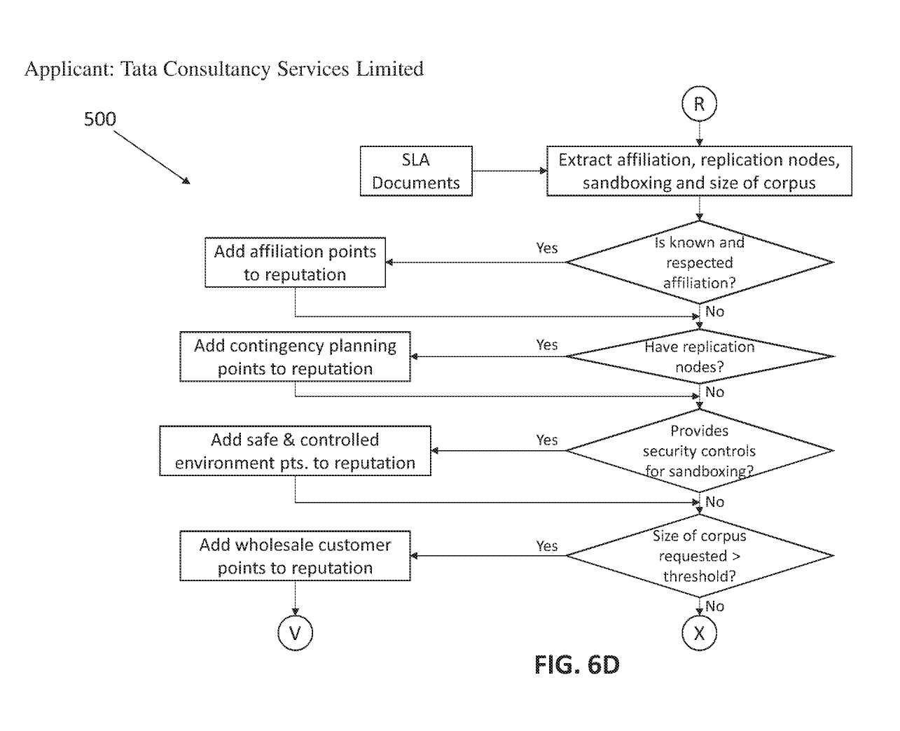

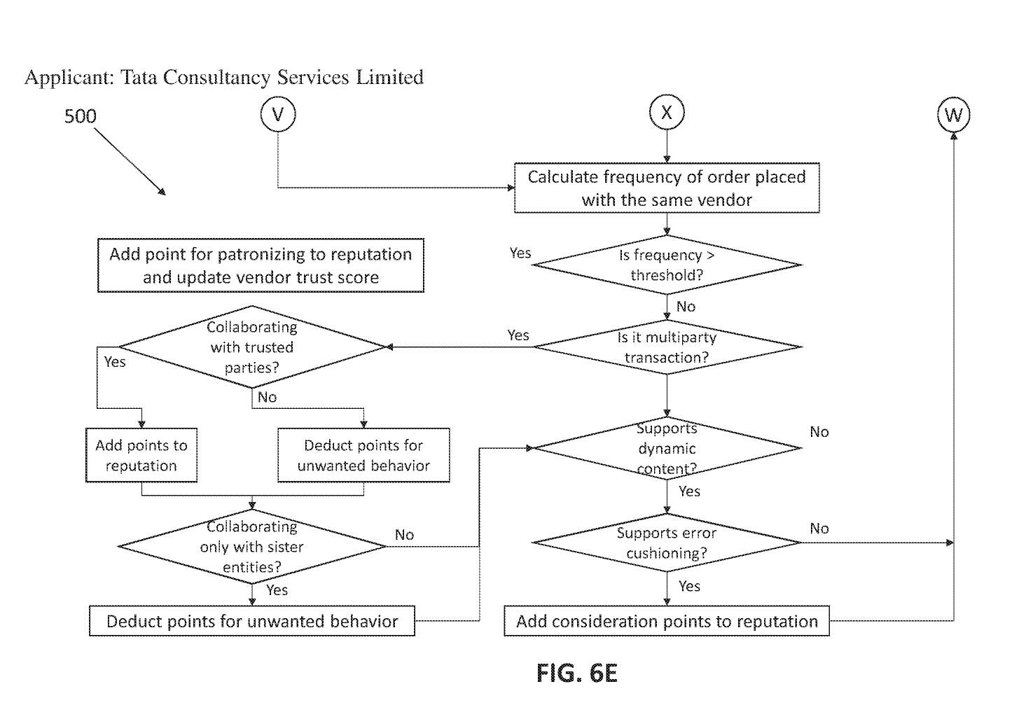

FIGS. 6A, 6B, 6C, 6D, 6E shows a flowchart 500 illustrating the steps involved in managing the reputation of the seller or the buyer in the data market place. It should be appreciated that the flowchart 500 should be read in conjunction with explanation of various modules and steps as explained in FIG. 1 and FIGS. 3A, 3B, 3C. Initially reputation score of the user is set as zero. In the next step, the reputation score of the user is updated, if the user has karma points. In the next step when the new transaction comes up, the affiliation, replication nodes, sandboxing, corpus repository and market reach are extracted from the SLA document. In the next step, it is checked if this is known affiliation. If yes then affiliation points are added to the reputation score. In the next step, contingency planning points are added to the reputation score if replication have nodes. In the next step, points are added to the reputation score for sampling and secure verification if sandboxing is provided for verification. Finally, wholesale seller points are added to the reputation score if the size of corpus is more than a threshold.

In the next step, it is also checked that if this is a multi-party transaction. Based on the collaboration with the trusted parties, citizen points are added to the reputation or points deducted from the reputation score. In the next step, it is checked whether there is any collaboration with the sister parties and accordingly points are deducted from the reputation score. If this is not multi-party transaction, then it is checked whether it supports dynamic content and supports error cushioning. Based on the checking either consideration points are added to the reputation score or list of pending complaints are updated.

Going back to earlier step, if that is not the new transaction, then list of pending complaints are updated. In the next step, status of the complaint is checked. If this is not filed by self then three points are checked. First, if this is not a valid complaint then a fixed percentage of points are added to the reputation score for the party. Second, if the complaint is not pending with the party then a fixed percentage of points are deducted from the reputation score for the party. Third, if the complaint is not pending for a maximum wait time then a fixed percentage of points are deducted from the reputation score for the party. In the next step, if the complaint is filed by the self then it is checked whether it is pending with self then two aspects are checked. First, If pending with self then complaint is decayed if it pending for more than a maximum wait time. Second, complaint score is less than a threshold, then the complaint is marked dead and the complaint is removed from the queue and a fixed percent of score is deducted from the party's reputation score. In the next step, if the complaint is not pending with the self then it is checked whether this is a false complaint. The false complaint counter is updated by one and complaint is marked dead once it crosses the threshold of maximum false count.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A method for complaint and reputation management of users in a data marketplace, the method comprising a processor implemented steps of:
accessing the data marketplace by the users for a data transaction;
calculating an initial reputation score of each of the users using a reputation calculation module if the user is a new user, else;
retrieving and updating the reputation score of the user from a reputation bank;
updating the reputation score of the user if there is a complaint against the user, wherein the reputation score is updated after verification as per a first set of predefined conditions;
checking if there is an influencer in the data transaction;
checking if there is an insider trading in the data transaction, wherein updating the reputation score of each of the users if there is at least one of influencer or insider trading in the data transaction after verification as per a second set of predefined conditions;
checking if there is the user inactive in the data marketplace, wherein decaying the reputation score of the user if the user is inactive in the data marketplace for more than a specified inactivity time period;
gathering a set of insights from the data transaction for future transactions; and
updating the final reputation score of each of the users in the reputation bank.

2. The method of claim 1 further comprising decaying the reputation of the user in case the user is unresponsive to the complaint against the user and removing the related complaint from the data marketplace.

3. The method of claim 1, wherein the user is a set of buyers or a set of sellers in the data transaction.

4. The method of claim 1, further comprising a loss minimization module for evaluating the user's capability for providing a secure environment for data usage if the user is a buyer of the data.

5. The method of claim 1, wherein the first set of predefined conditions includes criteria for verifying the validity of the complaint.

6. The method of claim 1, wherein the second set of predefined conditions includes criteria for verifying the validity of influencer and the insider trader.

7. The method of claim 1 further comprising a trust ranking algorithm for updating the reputation score of the user, wherein the trust ranking algorithm generates a trust score based on a trustworthiness of the user.

8. The method of claim 1, wherein the data used in the data transaction has a data credit score based on the demand of the data.

9. The method of claim 1 further comprises the step of dispute resolution between the set of buyers and the set of sellers through a set of independent parties in a secure way

10. The method of claim 1, wherein the data marketplace is a multiparty data marketplace.

11. The method of claim 1, wherein the reputation score is calculated based on at least one or more of history of the user, affiliation, quality, corpus size, trust, delivery time, market reach, payment time, request frequency, peer network of the user.

12. A system for complaint and reputation management of users in a data marketplace, the system comprises:
a user interface for accessing the data marketplace by the users for a data transaction;
a memory; and
a processor in communication with the memory, the processor further configured to perform the steps of:
calculating an initial reputation score of each of the users using a reputation calculation module if the user is a new user, else;
retrieving and updating the reputation score of the user from a reputation bank;
updating the reputation score of the user if there is a complaint against the user, wherein the reputation score is updated after verification as per a first set of predefined conditions;
checking if there is an influencer in the data transaction;
checking if there is an insider trading in the data transaction, wherein updating the reputation score of each of the users if there is at least one of influencer or insider trading in the data transaction after verification as per a second set of predefined conditions;
checking if there is the user inactive in the data marketplace, wherein decaying the reputation score of the user if the user is inactive in the data marketplace for more than a specified inactivity time period;
gathering a set of insights from the data transaction for future transactions; and
updating the final reputation score of each of the users in the reputation bank.

13. A non-transitory computer-readable medium having embodied thereon a computer program for complaint and reputation management of users in a data marketplace, the method comprising a processor implemented steps of:
accessing the data marketplace by the users for a data transaction;
calculating an initial reputation score of each of the users using a reputation calculation module if the user is a new user, else;
retrieving and updating the reputation score of the user from a reputation bank;
updating the reputation score of the user if there is a complaint against the user, wherein the reputation score is updated after verification as per a first set of predefined conditions;
checking if there is an influencer in the data transaction;
checking if there is an insider trading in the data transaction, wherein updating the reputation score of each of the users if there is at least one of influencer or insider trading in the data transaction after verification as per a second set of predefined conditions;
checking if there is the user inactive in the data marketplace, wherein decaying the reputation score of the user if the user is inactive in the data marketplace for more than a specified inactivity time period;
gathering a set of insights from the data transaction for future transactions; and
updating the final reputation score of each of the users in the reputation bank.
